(19) United States
(12) Patent Application Publication
(10) Pub. No.: US 2009/0110571 A1
(43) Pub. Date: Apr. 30, 2009

(54) HYDRAULIC PUMP FOR BRAKE SYSTEM

(75) Inventor: Yong Kap KIM, Gyeonggi-do (KR)

Correspondence Address: LADAS & PARRY, 5670 WILSHIRE BOULEVARD, SUITE 2100, LOS ANGELES, CA, 90036-5679, US

(73) Assignee: MANDO CORPORATION, Gyeonggi-do (KR)

(21) Appl. No.: 12/125,336

(22) Filed: May 22, 2008

(30) Foreign Application Priority Data
Oct. 29, 2007 (KR) 10-2007-108804

(51) Int. Cl. F04B 53/20; F15B 21/04

(52) U.S. Cl. 417/313; 417/559; 92/78

(57) ABSTRACT

Disclosed is a hydraulic pump for a brake system including a piston installed in a bore formed in the modulator block having an inlet and an outlet such that the piston can reciprocate and having a channel communicating with the inlet, a plug installed in the bore for dividing the inside of the bore into a pressure chamber, in which the piston is located, and a discharge chamber communicating with the outlet and having an orifice communicating the pressure chamber and the discharge chamber with each other, and a discharge valve installed in the discharge chamber for opening and closing the orifice, wherein a filter for filtering oil, fed into the bore through the inlet, is installed in the bore, and surrounds the outer surface of the piston so as to guide the piston. Since the filter for filtering the oil serves as a guide member guiding the piston as well as a filtering member, the hydraulic pump reduces the number of components and reduces an occupied space.

### CROSS-REFERENCE TO RELATED APPLICATION

This application claims the benefit of Korean Patent Application No. 2007- 0108804, filed Oct. 29, 2007, in the Korean Intellectual Property Office, the disclosure of which is incorporated herein by reference.

### BACKGROUND OF THE INVENTION

1. Field of the Invention

The present invention relates to a hydraulic pump for a brake system, and more particularly, to a hydraulic pump for a brake system, which is improved so as to reduce the number of components and reduce an occupied space.

2. Description of the Related Art

An electronic control brake system, which is installed in a vehicle, intermits hydraulic brake pressure transmitted to wheels of the vehicle and thus prevents the wheels from slipping on the road surface, thereby safely braking the vehicle.

Such a brake system includes a plurality of solenoid valves, low-pressure accumulators and high-pressure accumulators for temporarily storing oil, a motor and hydraulic pumps for pumping the oil temporarily stored in the low-pressure accumulators, and an electronic control unit for controlling the driving of the solenoid valves and the motor. The above components are compactly connected to a modulator block made of aluminum.

FIG. 1 is a hydraulic circuit diagram in a modulator block of a general brake system.

As shown in FIG. 1, a plurality of solenoid valves 11a and 11b for opening and closing channels formed in a modulator block 10 of a brake system, a motor 13 and hydraulic pumps 20 for pressurizing restored oil, and low-pressure accumulators 12 and high-pressure accumulators 15 respectively disposed on upstream and downstream channels of the hydraulic pumps 20 are installed in the modulator block 10. These components are interconnected through a plurality of channels formed in the modulator block 10, and serve to intermit hydraulic brake pressure, which is transmitted from a master cylinder 16 to wheel cylinders 17 of wheels under the condition that the operation of the components is controlled by an electronic control unit (not shown).

The hydraulic pumps 20 pressurize brake oil restored to the low-pressure accumulators 12 along hydraulic lines, and transmit the oil to the wheel cylinders 17 of the wheels, thus allowing the wheels to be intermittently braked.

FIG. 2 is a schematic cross-sectional view of a conventional hydraulic pump 20.

As shown in FIG. 2, the conventional hydraulic pump 20 includes a piston 22 advancing and retreating by the operation of a motor 13 and pressurizing oil in a pressure chamber 21, an inflow valve 23 installed at the downstream end of the piston 22 for opening and closing an inlet of the pressure chamber 21, a discharge valve 24 for opening and closing an outlet of the pressure chamber 21 by a variation of the pressure in the pressure chamber 21 according to the advance and retreat of the piston 22, and a guide member 25 installed on the circumference of the piston 22 so as to guide the advance and retreat of the piston 22. Further, a sealing member 26 is installed between the outer surface of the piton 22 and the inner surface of the guide member 25.

In the conventional hydraulic pump 20, when the piston 22 advances close to the pressure chamber 21, the oil in the pressure chamber 21 is pressurized, the discharge valve 24 is opened by the pressurizing force, and the oil in the pressure chamber 21 is discharged through a discharge hole 10a. Further, when the piston 22 retreats distant from the pressure chamber 21, the pressure in the pressure chamber 21 is lowered, the inflow valve 23 is opened, and oil is fed to the pressure chamber 21 through an inlet 10b.

In the case that a filter (not shown) for filtering the oil fed through the inlet 10b is installed in the above conventional hydraulic pump, the conventional hydraulic pump must secure a space for installing the filter, and thus increases an occupied space.

### SUMMARY OF THE INVENTION

Therefore, one aspect of the invention is to provide a hydraulic pump for a brake system, which reduces the number of components and reduces an occupied space.

In accordance with one aspect, the present invention provides a hydraulic pump for a brake system comprising a piston installed in a bore formed in the modulator block having an inlet and an outlet such that the piston can reciprocate and having a channel communicating with the inlet, a plug installed in the bore for dividing the inside of the bore into a pressure chamber, in which the piston is located, and a discharge chamber communicating with the outlet and having an orifice communicating the pressure chamber and the discharge chamber with each other, and a discharge valve installed in the discharge chamber for opening and closing the orifice, wherein a filter for filtering oil, fed into the bore through the inlet, is installed in the bore, and surrounds the outer surface of the piston so as to guide the piston.

The filter may include a frame surrounding the outer surface of the piston and having openings for communicating the inlet and the channel of the piston, and a filtering member installed in the openings for filtering oil fed into the frame through the openings.

A sealing part having an increased thickness, which surrounds the piston, may be provided on the frame so as to guide and seal the piston simultaneously.

A sealing member for sealing the piston may be provided at both upstream and downstream ends of the filter or any one of upstream and downstream ends of the filter.

### BRIEF DESCRIPTION OF THE DRAWINGS

These and/or other aspects and advantages of the invention will become apparent and more readily appreciated from the following description of the embodiments, taken in conjunction with the accompanying drawings in which:

FIG. 1 is a hydraulic circuit diagram in a modulator block of a general brake system;

FIG. 2 is a schematic cross-sectional view of a conventional hydraulic pump for a brake system;

FIG. 3 is a schematic cross-sectional view of a hydraulic pump for a brake system in accordance with one embodiment of the present invention;

FIG. 4 is a schematic cross-sectional view of a filter of the hydraulic pump of FIG. 3; and

FIG. 5 is a schematic cross-sectional view of a hydraulic pump for a brake system in accordance with another embodiment of the present invention.

### DETAILED DESCRIPTION OF THE PREFERRED EMBODIMENTS

Reference will now be made in detail to the embodiments of the present invention, an example of which is illustrated in the accompanying drawings, wherein like reference numerals refer to like elements throughout. The embodiments are described below to explain the present invention by referring to the annexed drawings.

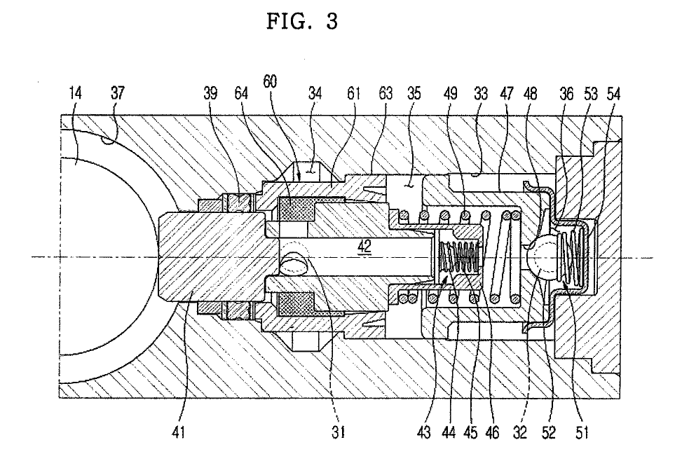

As shown in FIG. 3, a hydraulic pump for a brake system in accordance with one embodiment of the present invention is installed in a modulator block 30 having an inlet 31 and an outlet 32, and pressurizes oil fed to the inside of the modulator block 30 through the inlet 31 and then discharges the pressurized oil to the outside of the modulator block 30 through the outlet 32.

The hydraulic pump for the brake system of this embodiment includes a piston 41 installed in a bore 33 formed in the modulator block 30 such that the piston 41 can reciprocate, a plug 47 installed in the bore 33 for dividing the inside of the bore 33 into a pressure chamber 35 and a discharge chamber 36, a discharge valve 51 for opening and closing an orifice 48 provided in the plug 47 so as to connect the pressure chamber 35 and the discharge chamber 36, an inflow valve 43 for opening and closing a channel 42 connecting the pressure chamber 35 and an inflow chamber 34, provided at the upstream region of the pressure chamber 35 to be divided from the pressure chamber 35, and a filter 60 for filtering the oil fed to the inside of the modulator block 30 through the inlet 31.

The inside of the bore 33 of the modulator block 30 is divided into the inflow chamber 34 communicating with the inlet 31, the pressure chamber 35 provided at the downstream region of the inflow chamber 34 such that the oil in the pressure chamber 35 is pressurized by the piston 41, and the discharge chamber 36 provided at the downstream region of the pressure chamber 35 and communicating with the outlet 32. The discharge chamber 36 is closed by a cover member 38 connected to the modulator block 30.

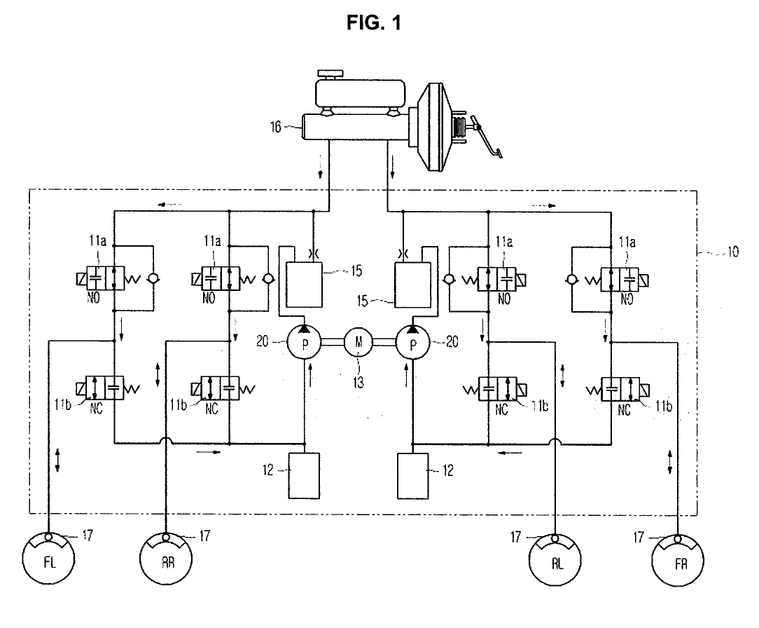

The piston 41 has a length from an eccentric shaft operating chamber 37, in which an eccentric shaft 14 provided on the motor (13 of FIG. 1) is located, to the inflow chamber 34 and the pressure chamber 35. A sealing member 39 for sealing the piston 41 is provided between the eccentric shaft operating chamber 37 and the inflow chamber 34. A channel 42 is provided at the downstream region of the piston 41, i.e., a region of the piston 41 located in the inflow chamber 34 and the pressure chamber 35. The channel 42 communicates with the inflow chamber 34, and communicates the inflow chamber 34 and the pressure chamber 35 with each other. Such a channel 42 is opened and closed by the inflow valve 43 installed at the end of the piston 41.

The inflow valve 43 includes a shielding member 44 contacting the downstream end of the piston 41 and closing the channel 42, a valve spring 45 elastically supporting the shielding member 44, and a retainer 46 connected to the downstream end of the piston 41 for supporting the valve spring 45. The shielding member 44 closes the channel 42 due to the elasticity of the valve spring 45, and is separated from the downstream end of the piston 41 by a difference of pressures between the channel 42 and the pressure chamber 35 and thus opens the channel 42, when the oil is discharged from the pressure chamber 35 and thus the pressure of the pressure chamber 35 is lowered.

The plug 47 is installed in the bore 33, and divides the inside of the bore 33 into the pressure chamber 35 and the discharge chamber 36. The orifice 48 communicating the pressure chamber 35 and the discharge chamber 36 with each other is provided at the downstream end of the plug 47. The orifice 48 is opened and closed by the discharge valve 51 installed in the discharge chamber 36.

The discharge valve 51 includes a shielding member 52 closing the orifice 48, a valve spring 53 elastically supporting the shielding member 52, and a retainer 54 connected to the downstream end of the plug 47 for supporting the valve spring 53. The shielding member 52 closes the orifice 48 due to the elasticity of the valve spring 53, and is separated from the plug 47 by the pressure of the oil in the pressure chamber 35 and thus opens the orifice 48, when the oil in the pressure chamber 35 is pressurized by the piston 41.

Further, the plug 47 supports a piston spring 49 elastically supporting the piston 41. The piston spring 49 pushes the piston 41 toward the eccentric shaft 14, and reciprocates the piston 41 together with the eccentric shaft 14.

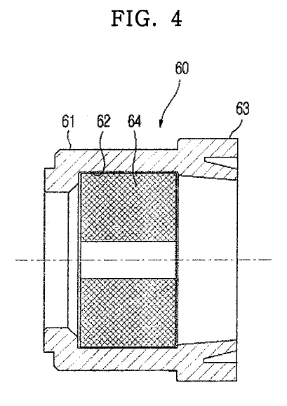

The filter 60 is installed in the inflow chamber 34, and filters the oil fed into the inflow chamber 34 through the inlet 31. As shown in FIGS. 3 and 4, the filter 60 includes a frame 61, which is inserted into the bore 33 by pressing and simultaneously guides and seals the piston 41 to divide the inflow chamber 34 and the pressure chamber 35 from each other, and a filtering member 64 installed in a plurality of openings 62, provided on the circumference of the frame 61, for filtering the oil fed from the outside of the frame 61 to the inside of the frame 61. A sealing part 63 surrounding the circumference of the piston 41 is provided at the downstream end of the cylindrical frame 61. The sealing part 63 is a part having a larger thickness than those of other parts of the frame 61. The sealing part 63 is attached closely to the outer surface of the piston 41, and thus serves as a sealing member sealing the piston 41.

In the hydraulic pump for the brake system in accordance with this embodiment of the present invention, the oil fed into the inflow chamber 34 through the inlet 31 is supplied to the inside of the filter 60, and then transmitted to the channel 42 at the center of the piston 41. Then, when the piston 41 is pressed by the eccentric shaft 14 and thus moves toward the pressure chamber 35, the oil in the pressure chamber 35 is pressurized, and the shielding member 52 of the discharge valve 51 is separated from the plug 47 due to the pressurizing force of the oil and then opens the orifice 48. Here, the oil in the pressure chamber 35 passes through the discharge chamber 36 and is discharged to the outside through the outlet 32.

Continuously, when the eccentric shaft 14 is distant from the piston 41, the piston 41 is pushed to the eccentric shaft operating chamber 37 due to the elastic restoring force of the piston spring 49. Then, the pressure of the pressure chamber 35 becomes lower than that of the channel 42 of the piston 41, and the shielding member 44 of the inflow valve 43 is separated from the piston 41 and opens the channel 42. Thus, the oil in the channel 42 is supplied to the pressure chamber 35.

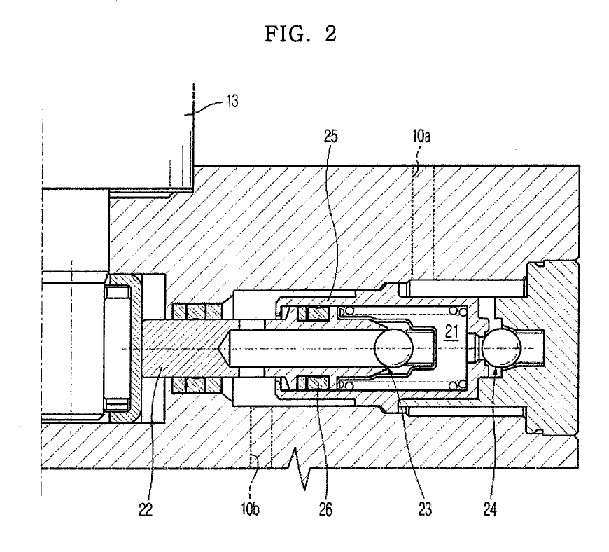

In the hydraulic pump for the brake system of the present invention, the filter 60 serves as a guide member (25 of FIG. 2) guiding the piston 41 and a sealing member sealing the piston 41 as well as serving to filter the oil. Therefore, the hydraulic pump for the brake system of the present invention can omit the guide member 25 and the sealing member, and thus reduces the number of components and has a simple structure compared with a conventional hydraulic pump.

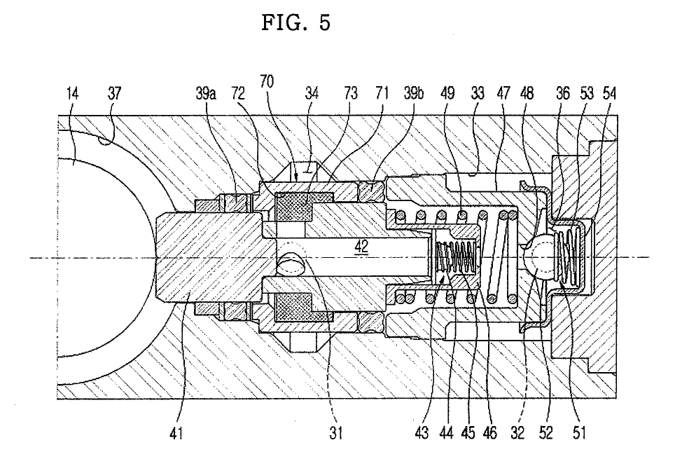

FIG. 5 is a schematic cross-sectional view of a hydraulic pump for a brake system in accordance with another embodiment of the present invention.

Some parts of the hydraulic pump in this embodiment shown in FIG. 5 are substantially the same as those of the hydraulic pump in the preceding embodiment and thus denoted by the same reference numerals even though they are depicted in different drawings.

The hydraulic pump for the brake system of this embodiment includes a piston 41 installed in a bore 33 formed in the modulator block 30 such that the piston 41 can reciprocate, a plug 47 for dividing the inside of the bore 33 into a pressure chamber 35 and a discharge chamber 36, a discharge valve 51 for opening and closing an orifice 48 provided in the plug 47, an inflow valve 43 for opening and closing a channel 42 connecting an inflow chamber 34 and the pressure chamber 35, and a filter 70 for filtering the oil fed to the inside of the modulator block 30 through an inlet 31.

Further, sealing members 39a and 39b for sealing the piston 41 are respectively provided at upstream and downstream ends of the filter 70, a piston spring 49 for elastically supporting the piston 41 is installed on the plug 47, and the bore 33 is closed by a cover member 38.

The filter 70 includes a cylindrical frame 71 guiding the piston 41, and a filtering member 73 provided in openings 72 of the frame 71. The downstream end of the frame 71 contacts the outer surface of the piston 41, and thus guides and seals the pistons 41 simultaneously.

In the hydraulic pump for the brake system of this embodiment, the sealing members 39a and 39b attached closely to the piston 41 are respectively installed at the upstream and downstream ends of the filter 70, and the sealing efficiency of the piston 41 is enhanced.

Other parts of the hydraulic pump in this embodiment are substantially the same as those of the hydraulic pump in the preceding embodiment, and a detailed description thereof will thus be omitted because it is considered to be unnecessary.

As apparent from the above description, the present invention provides a hydraulic pump for a brake system, in which a filter for filtering oil fed into a pressure chamber serves as a guide member as well as a filtering member, thus reducing the number of components and reducing an occupied space. Thereby, it is possible to reduce the size of a hydraulic pump product and cut down production costs.

Although embodiments of the invention have been shown and described, it would be appreciated by those skilled in the art that changes may be made in these embodiments without departing from the principles and spirit of the invention, the scope of which is defined in the claims and their equivalents.

What is claimed is:

1. A hydraulic pump for a brake system comprising a piston installed in a bore formed in the modulator block having an inlet and an outlet such that the piston can reciprocate and having a channel communicating with the inlet, a plug installed in the bore for dividing the inside of the bore into a pressure chamber, in which the piston is located, and a discharge chamber communicating with the outlet and having an orifice communicating the pressure chamber and the discharge chamber with each other, and a discharge valve installed in the discharge chamber for opening and closing the orifice,
wherein a filter for filtering oil, fed into the bore through the inlet, is installed in the bore, and surrounds the outer surface of the piston so as to guide the piston.

2. The hydraulic pump according to claim 1, wherein the filter includes a frame surrounding the outer surface of the piston and having openings for communicating the inlet and the channel of the piston, and a filtering member installed in the openings for filtering oil fed into the frame through the openings.

3. The hydraulic pump according to claim 1, wherein a sealing part having an increased thickness, which surrounds the piston, is provided on the frame so as to guide and seal the piston simultaneously.

4. The hydraulic pump according to claim 3, wherein a sealing member for sealing the piston is provided at both upstream and downstream ends of the filter or any one of upstream and downstream ends of the filter.
